(19) United States
(12) Patent Application Publication
(10) Pub. No.: US 2003/0208339 A1
(43) Pub. Date: Nov. 6, 2003

(54) Remote reading method of gauge data

(75) Inventors: Eul-Jung Hwang, Jinju city (KR); Sung-Ju Jang, Jinju city (KR); Il-Gwon Jeong, Sacheon city (KR)

Correspondence Address: Frank Chau, F. CHAU & ASSOCIATES, LLP, Suite 501, 1900 Hempstead Turnpike, East Meadow, NY, 11554, US

(73) Assignee: Chaos Co., Ltd.

(21) Appl. No.: 10/427,848

(22) Filed: May 1, 2003

(30) Foreign Application Priority Data
May 2, 2002 (KR) 2002-24049

(51) Int. Cl. G06F 15/00

(52) U.S. Cl. 702/188

(57) ABSTRACT

Disclosed is a remote reading method of gauge data in which gauge data is obtained by a customer's computer, and the obtained data is transmitted to a gauge data collection computer of a utility service provider such as a provider of gas, electricity, water, or hot water via a network. In a meter reading system provided with the gauge data collection computer, a plurality of customers' computers, and a plurality of meters, the method comprises the steps of (a) allowing each of the customers' computers to read the gauge data from the corresponding one of the meters at a designated time, and to store the read data in its memory, and (b) allowing each of the customers' computers to transmit the stored data to the gauge data collection computer at a predetermined time after the designated date, differently from predetermined times regarding other customers' computers.

### TECHNICAL FIELD

The present invention relates to a remote reading method of gauge data, and more particularly to a remote reading method of gauge data in which gauge data from each of customers' meters is obtained by the corresponding one of customers' computers, and the obtained data is transmitted to a gauge data collection computer of a utility service provider such as a provider of gas, electricity, water, or hot water connected to the customers' computers via a network.

### BACKGROUND ART

In conventional flow meters such as a water meter, etc., a main body is laid underground so that a flow transmission pipe laid underground passes through the main body, and a cover is detachably attached to the main body so as to protect the meter installed within the main body from external stresses. In order to impose fees on customers, a monthly amount of consumption of each customer must be individually read out. Such a meter reading system depends on human labor. Accordingly, a meter reader must personally open individually the cover from the main body of the water meter and read a counter installed in the main body, thus performing the meter reading.

In case that the water meter is installed outside a house or a building, the meter reader easily reads the meter regardless of a customer's presence or absence. However, since the conventional water meter is usually installed indoors, it is difficult to read the meter during a customer's absence. This causes the meter reader to visit the customer several times, thus unavoidably increasing the number of meter readers and the necessary manpower expense, and causing inefficiency in meter reading.

In order to solve such a problem, various methods have been proposed. However, in the proposed methods, a meter reader must perform a final confirmation step with a hand-held terminal. Accordingly, the proposed methods cause inconvenience to the meter reader.

In order to solve the aforementioned problems, several systems and/or methods for transmitting gauge data of at least one meter installed in a home to a gauge data collection computer of a relevant utility service provider using a network have been developed. However, as the number of customers' meters increases to an astronomical figure, when the customers randomly access the gauge data collection computer via the network, the gauge data collection computer of the relevant utility service provider and the network are overloaded, thus generating errors in reading the gauge data and calculating a consumption fee.

### SUMMARY OF THE INVENTION

Therefore, the present invention has been made in view of the above problems, and it is an object of the present invention to provide a remote reading method of gauge data, in which the gauge data of each of meters is stored in a memory of the corresponding one of customers' computers at a designated time, and data regarding the stored values in the memories of all the customers' computers are transmitted via a network to a gauge data collection computer of a utility service provider such as a provider of gas, electricity, water, and hot water at a predetermined time after the designated date.

It is another object of the present invention to provide a remote reading method of gauge data, in which the gauge data of a meter and its calculated consumption fee are read and displayed on a customer's computer installed in the customer's home, and the customer's computer is connected to a gauge data collection computer at a predetermined time so that data regarding the read results is transmitted to the gauge data collection computer.

It is yet another object of the present invention to provide a remote reading method of gauge data, in which, when a customer's computer transmits the gauge data of a meter and its calculated consumption fee to a gauge data collection computer, in case any one of the data transmitted from the customer's computer to the gauge data collection computer differs from the corresponding one of data stored in the gauge data collection computer, the gauge data collection computer immediately transmits its stored data to the customer's computer without reconnection of the customer's computer to the gauge data collection computer.

In accordance with one aspect of the present invention, the above and other objects can be accomplished by the provision of a remote reading method of gauge data, in a meter reading system provided with a gauge data collection computer of a utility service provider for providing gas, electricity, water, or hot water, a plurality of customers' computers each connected to the gauge data collection computer via a network, and a plurality of meters each for transmitting its gauge data to the corresponding one of the customers' computers, comprising the steps of: (a) allowing each of the customers' computers to read the gauge data from the corresponding one of the meters at a designated time, and to store the read data in its memory; and (b) allowing each of the customers' computers to transmit the stored data to the gauge data collection computer at a predetermined time after the designated date, differently from predetermined times regarding other customers' computers.

Preferably, the step (a) may include the step of allowing each of the customers' computers to store the gauge data counted by each of the meters in a storage area of the memory, and to store at the designated time the counted gauge data in a separated storage area of the memory.

Further, preferably, the step (b) may include the step of allowing each of the customers' computers to transmit the data stored in its memory to the gauge data collection computer at the designated time.

Moreover, preferably, the step (b) may include the steps of: (b-1) storing a quotient obtained by dividing a device number of customer's computer by a predetermined number of customers' computers accessible to the gauge data collection computer per day, as a day component of the transmission time; (b-2) storing a quotient obtained by dividing a remainder given at the step (b-1) by a predetermined number of customers' computers accessible to the gauge data collection computer per hour, as an hour component of the transmission time; (b-3) storing a quotient obtained by dividing a remainder given at the step (b-2) by a predetermined number of customers' computers accessible to the gauge data collection computer per minute, as a minute component of the transmission time; and (b-4) storing a value obtained by multiplying a remainder given at the step (b-3) by a predetermined time taken until one customer's computer communicates with the gauge data collection computer from the access to the gauge data collection computer, as a second component of the transmission time.

Preferably, the remote reading method of gauge data may further comprise the step of (c) allowing the gauge data collection computer to calculate a consumption fee based on the gauge data at the step (a), and to store the calculated consumption fee in its memory.

Further, preferably, the remote reading method of gauge data may further comprise the step of (d) displaying the gauge data at the step (b) and its calculated consumption fee on a display unit.

Moreover, preferably, the remote reading method of gauge data may further comprise the step of (e) allowing the gauge data collection computer, when any one of the data transmitted from each of the customers' computers to the gauge data collection computer at the step (b) differs from the corresponding one of data, including a fee schedule, a reading time, and a telephone number of the corresponding utility service, stored in the gauge data collection computer, to immediately transmit the stored data to the customer's computer.

Preferably, each of the meters may be a water meter, a hot water meter, a gas meter, or a watt-hour meter.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a remote meter reading system in accordance with the present invention;

FIG. 2 is a circuit diagram of the remote meter reading system in accordance with the present invention;

FIG. 3 is an exploded longitudinal sectional view of a meter of the remote meter reading system, being divided into upper and lower parts, in accordance with the present invention;

FIG. 4 is a circuit diagram of the meter in accordance with the present invention;

FIG. 5a is a flow chart of the operation of the meter in accordance with the present invention;

FIG. 5b is a flow chart of the operation of a customer's computer in accordance with the present invention;

FIG. 5c is a flow chart of the operation of a gauge data collection computer in accordance with the present invention;

FIG. 6 is a schematic view illustrating one exemplary operation for processing gauge data in the remote reading method of gauge data in accordance with the present invention; and

FIG. 7 is a schematic view of the structure of a memory of the customer's computer in FIG. 6.

### DETAILED DESCRIPTION OF THE PREFERRED EMBODIMENTS

Now, a preferred embodiment of the present invention will be described in detail with reference to the annexed drawings.

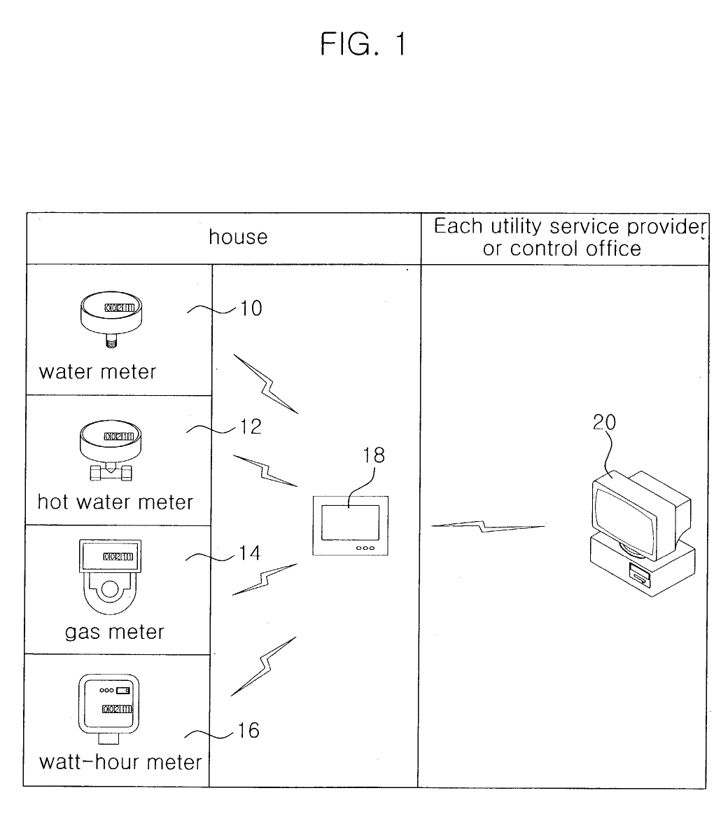

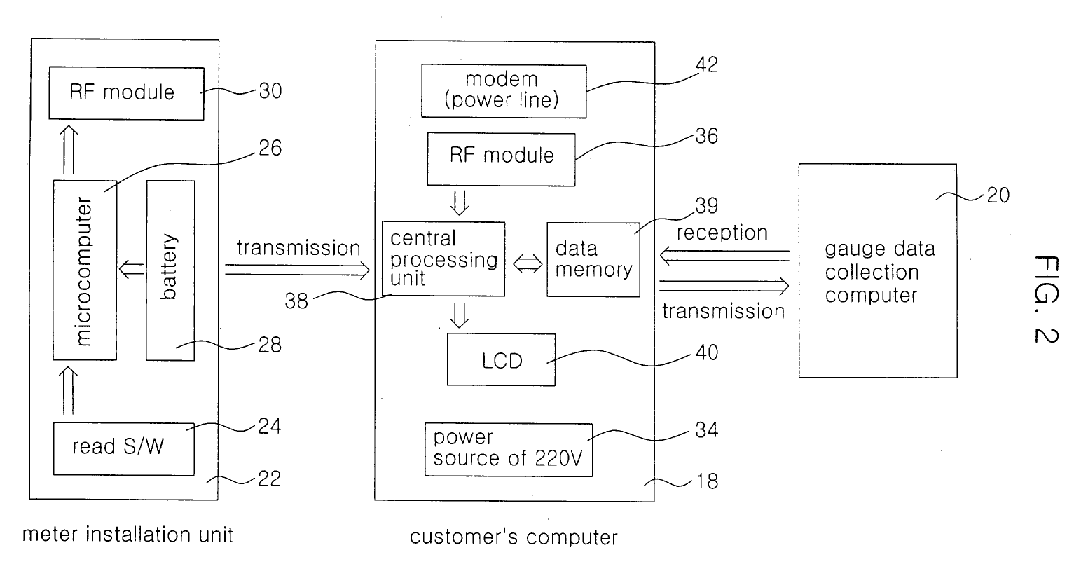

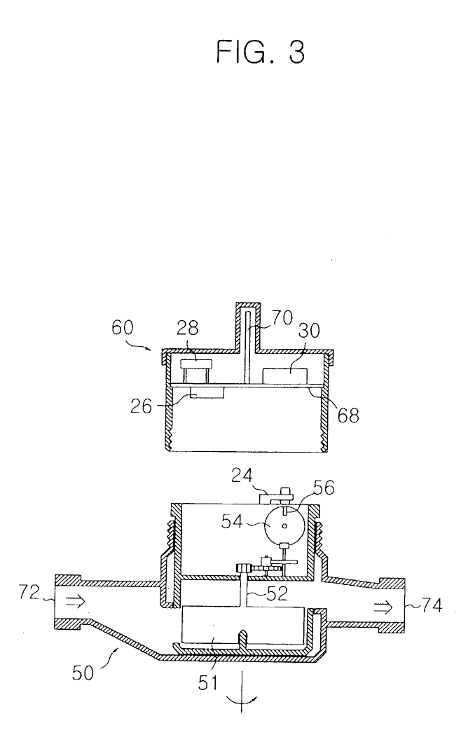

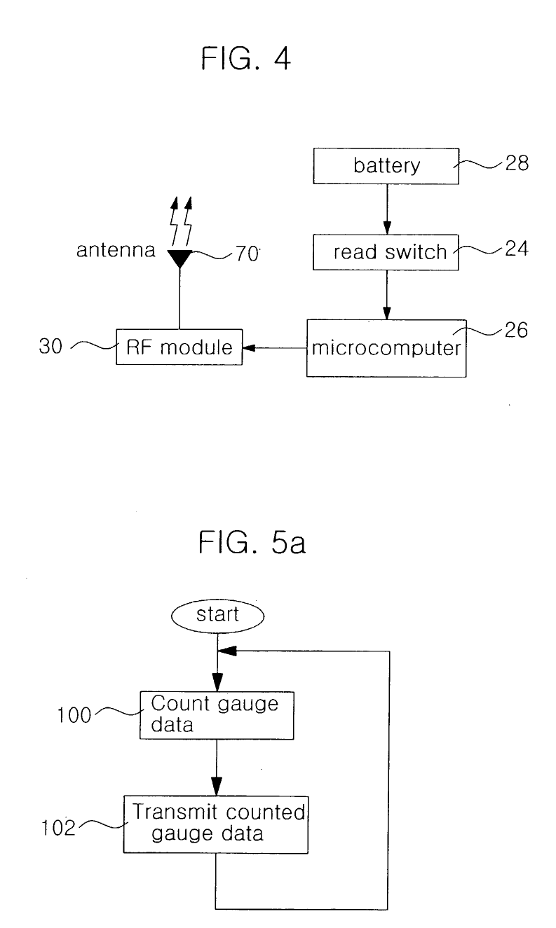

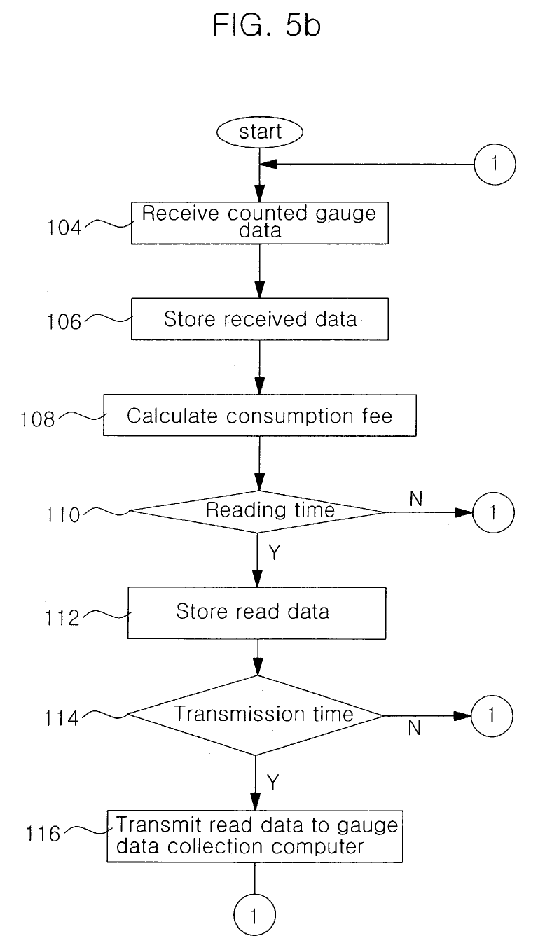

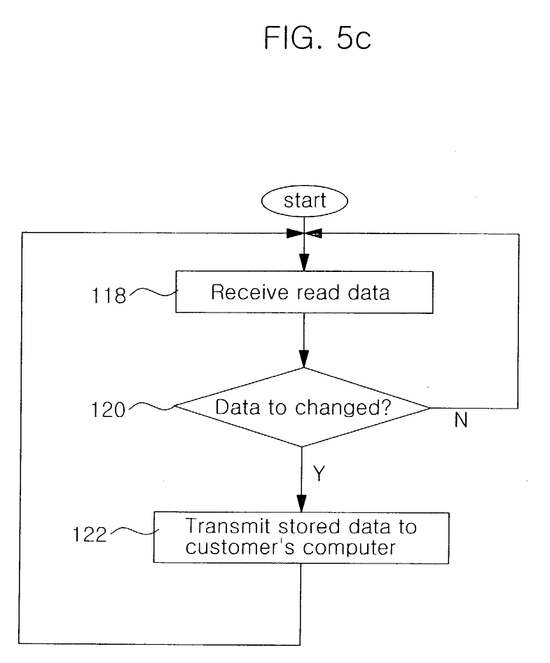

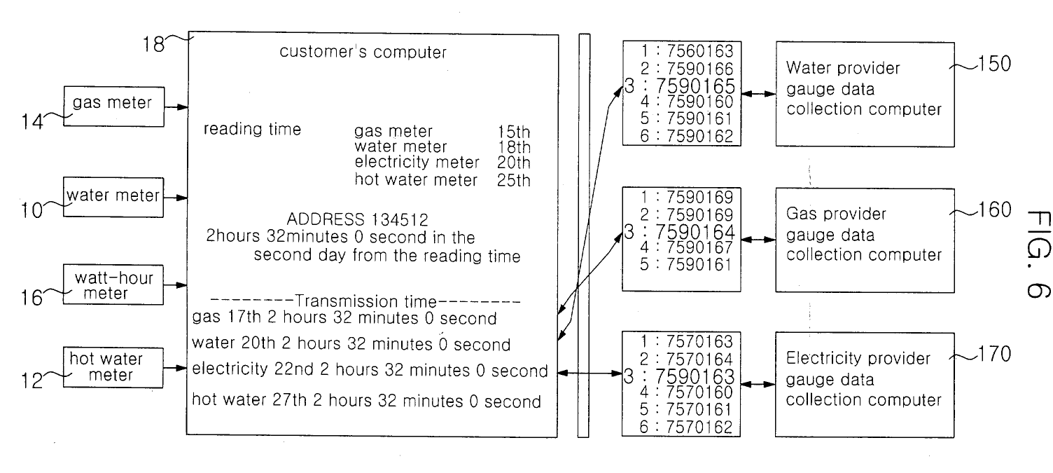

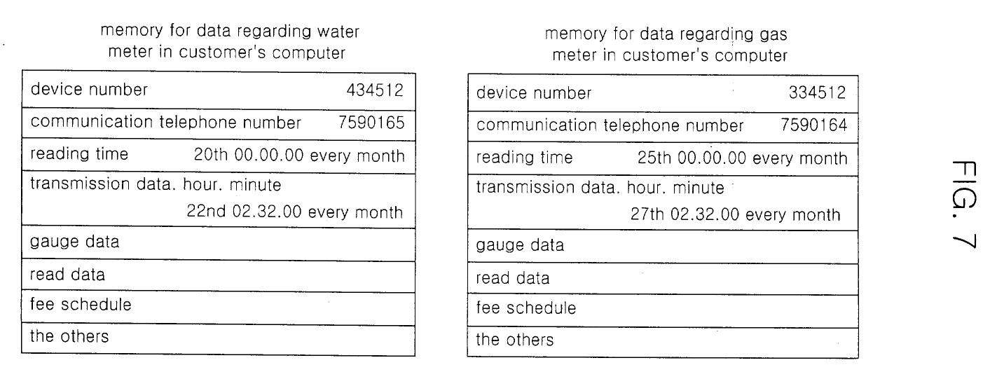

FIG. 1 is a schematic view of a remote meter reading system in accordance with the present invention. FIG. 2 is a circuit diagram of the remote meter reading system in accordance with the present invention. FIG. 3 is an exploded longitudinal sectional view of a meter of the remote meter reading system, being divided into upper and lower parts, in accordance with the present invention. FIG. 4 is a circuit diagram of the meter in accordance with the present invention. FIG. 5a is a flow chart of the operation of the meter in accordance with the present invention. FIG. 5b is a flow chart of the operation of a customer's computer in accordance with the present invention. FIG. 5c is a flow chart of the operation of a gauge data collection computer in accordance with the present invention. FIG. 6 is a schematic view illustrating one exemplary operation for processing gauge data in the remote reading method of gauge data in accordance with the present invention. FIG. 7 is a schematic view of the structure of a memory of the customer's computer in FIG. 6.

With reference to FIG. 1, the remote meter reading system of the present invention comprises a plurality of meters, a plurality of customers' computers 18, and a gauge data collection computer 20 connected to the customers' computers 18 via a network. The meters include a water meter 10, a hot water meter 12, a gas meter 14, a waft-hour meter 16, etc. Each of the meters wirelessly transmits its gauge data to the corresponding customer's computer 18.

The customer's computer 18 receives the gauge data from the meter, calculates a consumption fee based on the received gauge data, and stores the gauge data and the calculated consumption fee in separate storage areas. Further, the customer's computer 18 displays the gauge data and the consumption fee to the corresponding one of customers.

At a designated time, the customer's computer 18 stores gauge data of the meter and its calculated consumption fee in different storage areas separately from the above storage areas. At a predetermined time after the designated date, the customer's computer 18 transmits the data regarding the stored results, i.e., the gauge data and its calculated consumption fee, to the gauge data collection computer 20 via the network. The gauge data collection computer 20 receives the data transmitted from the customer's computer, and stores the received data in its database for the management of the data.

In the above remote meter reading system, the data transmission from the meter to the customer's computer 18 is wirelessly carried out. However, the meter may be connected to the corresponding customer's computer 18.

With reference to FIG. 2, when a read switch 24 operates in response to the rotation of a counter of the meter, the read switch 24 in a meter installation unit 22 detects a signal from the rotation of the counter by its signal detector, and inputs the detected signal to a microcomputer 26. When the microcomputer 26 receives the signal, a value of one is added to a figure stored in the microcomputer 26, and subsequently the resulting figure is stored in the microcomputer 26. That is, the microcomputer 26 counts the cumulative number of rotations of the counter of the meter.

The resulting figure of the microcomputer 26 is converted into a radio frequency (RF) signal through an RF module 30, and subsequently transmitted to the customer' computer 18 via an antenna. The microcomputer 26 is operated by power supplied from a battery 28.

The customer's computer 18 receives the radio frequency signal transmitted from the microcomputer 26.

The customer's computer 18 is operated by a power source 34 supplying a voltage of 220V. The customer's computer 18 receives the radio frequency signal transmitted from the meter installation unit 22, and converts the received radio frequency signal into an electrical signal through an RF module 36. The converted electrical signal is inputted to a central processing unit 38. The central processing unit 38 calculates consumption amount and fee based on the received electrical signal, and stores data regarding the calculated result in a memory 39. The stored data is displayed via a display unit such as an LCD 40, thereby allowing a customer in the customer's home to see the consumption amount and fee.

The stored data regarding the consumption amount and fee are stored in separate storage areas of the memory 39 at a designated time, and subsequently transmitted to the gauge data collection computer 20 of the relevant utility service provider such as a provider of gas, electricity, water, or hot water at a predetermined time after the designated date.

The data regarding the consumption amount and fee, inputted to the gauge data collection computer 20, are stored in a database so that the data are used to output a fee notice and/or to detect a leakage area of the meter.

Preferably, the gauge data collection computer 20 transmits commercial messages for advertisement to the customer's computer 18 so that the messages are displayed on the customer's computer 18.

Further, preferably, the battery 28 positioned on the upper part of the meter is a Lithium battery of 3V, which is usable for a long period of time.

As shown in FIG. 3, the meter of the remote meter reading system in accordance with the present invention is divided into the upper and lower parts 60 and 50. The lower part 50 of the meter includes a counter 54 positioned above a rotary shaft 52 of a rotary vane 51, a permanent magnet 56 located at a designated position of the counter 54, and a read switch 58 installed on the upper surface of the lower part 50. The upper part 60 of the meter includes a PCB 68 provided with an RF module 62, a battery 64 and a microcomputer 66, and an antenna 70.

A utility service such as water is introduce into the meter via an inlet 72, and subsequently discharged from the meter via an outlet 74. During such an operation, the rotary vane 51 is rotated in proportion to the flow rate in the meter. Here, the counter 54 connected to the upper surface of the rotary vane 52 is rotated also.

By the rotation of the counter 54, the permanent magnet 56 located on the counter 54 revolves around the rotary shaft 52 of the counter 54, thereby attracting the read switch 58 by means of the magnetic force. Accordingly, the read switch 58 is turned on/off, thus generating an electrical signal. When the electrical signal is inputted to the microcomputer 26, a value of one is added to the figure stored in a certain storage area of the microcomputer 26. Then, the resulting cumulative figure is stored again in the same storage area of the microcomputer 26, and converted into a radio frequency signal by the RF module 30. The converted radio frequency signal is transmitted to the outside via the antenna 70.

With reference to FIG. 4, the electrical signal generated by the on/off operation of the read switch 80 in response to the flow rate is processed by the microcomputer 26 of the meter. That is, the microcomputer 26 performs an appropriate calculation operation for the received flow rate based on predetermined addresses, i.e., matching values assigned to the respective customers' computers 18. The calculated result is converted into a radio frequency signal by the RF module 30, and subsequently outputted via the antenna 70. The above microcomputer 26 utilizes the battery 28 such as a Lithium battery.

Hereinafter, with reference to FIGS. 5a to 5c, a process for processing the gauge data is described in detail.

The electrical signal, generated by the on/off operation of the read switch 80 in response to the flow rate, is counted by the calculation of the microcomputer 26 provided with the memory so that a value of the electrical signal is added to the already-stored value, thereby obtaining the cumulative counted result (S100).

The counted result is stored in the memory within the microcomputer 26. Data regarding the stored result is converted into a radio frequency signal by the RF module 30, and wirelessly transmitted to the outside via the antenna 70 (S102). Then, the process is returned to step S100 (S100).

The wirelessly transmitted data is received by the customer's computer 18 via the antenna and the RF module 36 of the customer's computer 18 (S104). The received data is processed by the calculation of the central processing unit 38 of the customer's computer 18, and subsequently stored in the memory 39 (S106).

Initial values and device numbers of plural meters such as the water meter 10, the gas meter 12, the hot water meter 14 and the watt-hour meter 16, telephone numbers, meter reading times and fee schedules of the corresponding utility service providers, etc. are stored in the memory 39.

The customer's computer 18 receives gauge data from the water meter 10, the gas meter 12, the hot water meter 14 and the watt-hour meter 16, and stores the received data in the memory 39. The central processing unit 38 of the customer's computer 18 calculates a consumption fee based on the stored data, and stores the calculated consumption fee in the memory 39 also.

The customer's computer 18 determines whether it is time to read the corresponding meter (S110). When the present time reaches a designated reading date and time of the corresponding meter, read data containing the gauge data of the meter, its converted consumption fee, etc. are stored in a separate storage area (S112).

On the other hand, when the present time has not reached the designated reading date and time of the corresponding meter, the process is returned to step S104 (S104).

After the customer's computer 18 stores the read data at step S112 (S112), the customer's computer 18 determines whether it is time to access the gauge data collection computer 20 of the corresponding utility service provider (S114). When the present time reaches to a predetermined accessing time, the customer's computer 20 accesses the gauge data collection computer 20 via a network, and transmits the read data stored in the memory 39 to the gauge data collection computer 20 (S116).

The gauge data collection computer 20 of the corresponding utility service provider receives the data regarding the corresponding meter from the customer's computer 18 (S118).

The gauge data collection computer 20 of the corresponding utility service provider compares the received data to its stored data, and determines whether any one of the received data differs from the stored data including a fee schedule, a reading date and time, a telephone number, and etc (S120).

In case that any one of the received data, i.e., the data stored in the memory 39 of the customer's computer 18, differs from the corresponding one of the stored data in the gauge data collection computer 20, the gauge data collection computer 20 of the utility service provider transmits to the customer's computer 18 the corresponding one of its stored data to be substituted for the earlier one of the data stored in the customer's computer 18 (S122).

Here, the gauge data collection computer 20 does not transmit the corresponding one of its stored data to the customer's computer 18 at random. When the customer's computer 18 transmits the read data to the gauge data collection computer 20 at a predetermined time, the gauge date collection computer 20 compares the received data to its stored data, and, if any one of the received data differs from the corresponding one of the stored data, immediately transmits the corresponding one of the stored data to the customer's computer 18.

At step S120 (S120), in case that any one of the received data does not differ from the corresponding one of the stored data in the gauge data collection computer 20, the gauge data collection computer 20 accepts the data transmitted from the customer's computer 18.

Hereinafter, with reference to FIGS. 6 and 7, an exemplary method for processing the gauge data is described in detail.

As shown in FIG. 6, the telephone number (7590165) of a water provider 150, the telephone number (7590164) of a gas provider 160, and the telephone number (7590163) of an electricity provider 170 are stored in the memory 39 of the customer's computer 18 connected to the water meter 10 having the device number (434512), the gas meter 14 having the device number (234512), and the electricity mater 16 having the device number (334512).

Further, other data including the device numbers, reading times and fee schedules of the meters are stored in the memory 39 of the customer's computer 18.

Particularly, it is possible to set the reading time of the corresponding meter as a designated date based on the device number of the customer's computer 18 stored in its memory 39.

A process for calculating a transmission time by the customer's computer 18 is described, as follows.

The device number of the above customer's computer 18 is (134512). A first figure (1) denotes a number of a group to which the customer's computer 18 belongs, in the corresponding utility service provider. The remaining five figures (34512) must be the same as those of all meters installed at the corresponding customer's home.

A second figure (3) denotes a number of a communication line to which the customer's computer 18 belongs. Each of the utility service providers is provided with a plurality of communication lines.

The customer's computer 18 transmits its data to the gauge data collection computer 20 at a predetermined time (day, hour, minute, and second) after the reading time of each of the meters.

When the customer's computer 18 transmits its data to the gauge data collection computer 20, the remaining four figures (4512) are utilized.

The plural meters of one customer must be read at different designated dates every month.

Hereinafter, there will be described two methods for setting a transmission time after the above reading times, i.e., a time when the customer's computer 18 transmits its read data to the gauge data collection computer 20.

Now, the first method is described, as follows.

By using the last four figures (4512) of the device number (134512) of the customer's computer 18 as an address, the transmission time of the customer's computer 18 is calculated by the below formulas a) to d).

a) (Address)/(Number of customers' computers accessible to gauge data collection computer per day)=First quotient—First remainder (Here, the first quotient denotes a date of the transmission time)

b) (First remainder)/(Number of customers' computers accessible to gauge data collection computer per hour)=Second quotient—Second remainder (Here, the second quotient denotes an hour of the transmission time)

c) (Second remainder)/(Number of customers' computers accessible to gauge data collection computer per minute)=Third quotient—Third remainder (Here, the third quotient denotes a minute of the transmission time)

d) (Third remainder)*(Time taken until one customer's computer communicates with the gauge data collection computer from the access to the gauge data collection computer)=Resulting value (Here, the resulting value denotes a second of the transmission time)

Here, the last four figures (4512) out of the device number (134512) of the customer's computer 18 are used as the address. Further, (Number of customers' computers accessible to gauge data collection computer per day) is set to be “1800”, (Number of customers' computers accessible to gauge data collection computer per hour) is set to be “360”, and (Number of customers' computers accessible to gauge data collection computer per minute) is set to be “6”. When the above-set values are employed in the above formulas, the below results are obtained.

a) 4512/1800=2 (day)—912

b) 912/360=2 (hour)—192

c) 192/6=32 (minute)—0

d) 0*10=0 (second)

In accordance with the calculated results, the customer's indoor computer 18 transmits the read data, including the reading time, the device number of the meter, the gauge data of the meter, and the calculated consumption fee for the gauge data, to the gauge data collection computer 20 of the corresponding utility service provider at “2” days “2” hours “32” minutes “0” second after the designated reading time of each of the utility service providers based on the telephone number (7590165) of the water provider 150, the telephone number (7590164) of the gas provider 160, and the telephone number (7590163) of the electricity provider 170. Such a method can be applied in an integrated provider obtained by integrating the meter reading operations, the telephone numbers, and the accessing operations s of the plural providers.

The number of the customers' computers 18 accessible to the gauge data collection computer 20 per day, hour, or minute may be properly adjusted.

Preferably, the plural meters of one customer are read at different days.

Alternatively, there may be used the second method for forcibly setting a transmission time, in which a manager of the gauge data collection computer 20 in the corresponding utility service provider approves the transmission time, and subsequently the approved transmission time is recorded in the customer's computer 18.

In case that the gas meter 14 and the water meter 10 are read on the same date, it is preferable to add one day to the transmission time of one of the two meters 14 and 10, thereby allowing the two meters 14 and 10 to transmit their data to the gauge data collection computer 18 at different times.

Otherwise, in case that the transmission times of the plural meters installed at a customer's home are the same, the telephone numbers of the corresponding utility service providers are the same. Accordingly, it is possible to perform an integrated reading operation of the meters on the same date.

Industrial Applicability

As apparent from the above description, the present invention provides a remote reading method of gauge data, in which a customer computer displays the gauge date of a meter, calculates a consumption fee based on the gauge data, and accesses a gauge data collection computer of a utility service provider at a predetermined time based on the device number of the customer's computer, thereby preventing the gauge data collection computer from being overloaded and stably reading the meter.

Further, when the customer's computer transmits the read data and its calculated consumption fee to the gauge data collection computer, in case any one of the data transmitted from the customers' computers to the gauge data collection computer differs from the corresponding one of data stored in the gauge data collection computer, the gauge data collection computer immediately transmits its stored data to the customer's computer without reconnection of the customer's computer to the gauge data collection computer. Accordingly, it is possible to confirm a changed fee schedule, a changed telephone number of the corresponding utility service provider, etc., thereby providing reliable results.

Moreover, in the method of the present invention, the flow rates of the customers' meters at a designated area can be simultaneously read. Accordingly, it is possible to detect an area of leakage generated by a burst in pipes such as a water main, thereby rapidly coping with accidents caused by such a situation.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A remote reading method of gauge data, in a meter reading system provided with a gauge data collection computer of a utility service provider for providing gas, electricity, water, or hot water, a plurality of customers' computers each connected to the gauge data collection computer via a network, and a plurality of meters each for transmitting its gauge data to the corresponding one of the customers' computers, comprising the steps of:
(a) allowing each of the customers' computers to read the gauge data from the corresponding one of the meters at a designated time, and to store the read data in its memory; and
(b) allowing each of the customers' computers to transmit the stored data to the gauge data collection computer at a predetermined time after the designated date, differently from predetermined times regarding other customers' computers.

2. The remote reading method of gauge data as set forth in claim 1, wherein the step (a) includes the step of allowing each of the customers' computers to store the gauge data counted by each of the meters in a storage area of the memory, and to store at the designated time the counted gauge data in a separated storage area of the memory.

3. The remote reading method of gauge data as set forth in claim 1, wherein the step (b) includes the step of allowing each of the customers' computers to transmit the data stored in its memory to the gauge data collection computer at the designated time.

4. The remote reading method of gauge data as set forth in claim 3, wherein the step (b) includes the steps of:
(b-1) storing a quotient obtained by dividing a device number of the customer's computer by a predetermined number of customers' computers accessible to the gauge data collection computer per day, as a day component of the transmission time;
(b-2) storing a quotient obtained by dividing a remainder given at the step (b-1) by a predetermined number of customers' computers accessible to the gauge data collection computer per hour, as an hour component of the transmission time;
(b-3) storing a quotient obtained by dividing a remainder given at the step (b-2) by a predetermined number of customers' computers accessible to the gauge data collection computer per minute, as a minute component of the transmission time; and
(b-4) storing a value obtained by multiplying a remainder given at the step (b-3) by a predetermined time taken until one customer's computer communicates with the gauge data collection computer from the access to the gauge data collection computer, as a second component of the transmission time.

5. The remote reading method of gauge data as set forth in claim 1, further comprising the step of (c) allowing the gauge data collection computer to calculate a consumption fee based on the gauge data at the step (a), and to store the calculated consumption fee in its memory.

6. The remote reading method of gauge data as set forth in claim 1, further comprising the step of (d) displaying the gauge data at the step (b) and its calculated consumption fee on a display unit.

7. The remote reading method of gauge data as set forth in claim 1, further comprising the step of (e) allowing the gauge data collection computer, when any one of the data transmitted from each customers' computer to the gauge data collection computer at the step (b) differs from the corresponding one of data, including a fee schedule, a reading time, and a telephone number of the corresponding utility service, stored in the gauge data collection computer, to immediately transmit the stored data to the customer's computer.

8. The remote reading method of gauge data as set forth in claim 1, wherein each of the meters is a water meter.

9. The remote reading method of gauge data as set forth in claim 1, wherein each of the meters is a hot water meter.

10. The remote reading method of gauge data as set forth in claim 1, wherein each of the meters is a gas meter.

11. The remote reading method of gauge data as set forth in claim 1, wherein each of the meters is a watt-hour meter.
